(19) United States
(12) Patent Application Publication
(10) Pub. No.: US 2026/0177968 A1
(43) Pub. Date: Jun. 25, 2026

(54) IMAGE FORMING APPARATUS AND IMAGE FORMING METHOD

(71) Applicant: KONICA MINOLTA, INC., Tokyo (JP)

(72) Inventors: Ryo FUJIMITSU, Tokyo (JP); Nobuyasu TAMURA, Tokyo (JP); Shinichi TSUKAMURA, Uenohara-shi (JP); Hideaki TANAKA, Tokyo (JP); Atsushi NAKAMURA, Saitama-shi (JP); Daiki YAMANAKA, Sagamihara-shi (JP); Katsuya TOYOFUKU, Tokyo (JP)

(21) Appl. No.: 19/407,414

(22) Filed: Dec. 3, 2025

(30) Foreign Application Priority Data
Dec. 25, 2024 (JP) 2024-228412

(51) Int. Cl. G03G 15/00; G03G 15/20

(52) U.S. Cl. CPC G03G 15/6558; G03G 15/2064; G03G 15/5029; G03G 2215/00666; G03G 2215/00742; G03G 2215/00772; G03G 2215/1671

(57) ABSTRACT

An image forming apparatus includes: a temperature detection section configured to detect a temperature of a recording medium before a toner image is fixed to the recording medium; a preheating section configured to heat at least a front surface of the recording medium before the toner image is formed on the recording medium; and a controller configured to control heating by the preheating section during printing based on the temperature of the recording medium detected by the temperature detection section.

### CROSS REFERENCE TO RELATED APPLICATION

The entire disclosure of Japanese Patent Application No. 2024-228412, filed on Dec. 25, 2024, is incorporated herein by reference in its entirety.

### TECHNICAL FIELD

The present invention relates to an image forming apparatus and an image forming method.

### BACKGROUND OF THE INVENTION

When a sheet is cold under a low-temperature environment, fixing under-offset (low-temperature fixing) may occur because toner is less likely to be fused to the sheet or the temperature of the fixing member decreases. As a countermeasure therefor, the sheet is heated before fixing to increase the temperature of the sheet.

JP 2023-046717 A proposes a method in which a sheet is heated from both its front and back surfaces prior to printing. When the sheet reaches a predetermined temperature, the conveyance of the sheet is stopped, and the heated sheet is used to raise the temperature of a component located upstream of the fixing section.

JP 2017-116753 A proposes that a recording medium bearing toner is preheated from its back surface by a preheating section positioned upstream of the fixing section. Specifically, in the invention described in JP 2017-116753 A, the temperature of the sheet reaching the fixing section is predicted, and if the predicted temperature deviates from a predetermined value, the result is fed back to control the heating during the latter stage of the preheating process.

However, in the invention described in JP 2023-046717 A, when the sheet temperature changes during printing, the temperature of the sheet entering the fixing nip becomes unstable. Therefore, stabilization is difficult.

Furthermore, in a case where multilayer media such as thick paper or roll sheet is handled in the invention described in JP 2017-116753 A, heating from only the back surface is insufficient, and the sheet temperature may not be stable.

### SUMMARY OF THE INVENTION

It is an object of the present invention to provide an image forming apparatus and an image forming method capable of stabilizing the temperature of a recording medium.

To achieve at least one of the abovementioned objects, according to an aspect of the present invention, an image forming apparatus reflecting one aspect of the present invention comprises: a temperature detection section configured to detect a temperature of a recording medium before a toner image is fixed to the recording medium; a preheating section configured to heat at least a front surface of the recording medium before the toner image is formed on the recording medium; and a controller configured to control heating by the preheating section during printing based on the temperature of the recording medium detected by the temperature detection section.

Further, to achieve at least one of the abovementioned objects, according to an aspect of the present invention, an image forming method reflecting one aspect of the present invention comprises the steps of: a detection step of detecting a temperature of a recording medium before a toner image is fixed to the recording medium; a calculation step of calculating a temperature difference between the temperature of the recording medium and a preset target temperature as a correction amount; a heating step of heating at least a front surface of the recording medium at a temperature based on the correction amount and the target temperature; and a printing step of printing on the recording medium in which at least the front surface has been heated.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a view schematically illustrating the overall configuration of an image forming apparatus according to a first embodiment.

FIG. 2 is a block diagram illustrating the configuration of a main part of the image forming apparatus according to the first embodiment.

FIG. 3 is a view schematically illustrating the configuration of a fixing section in the first embodiment.

FIG. 4 is a view schematically illustrating a first exemplary configuration of a preheating section in the first embodiment.

FIG. 5 is a view schematically illustrating a second exemplary configuration of the preheating section in the first embodiment.

FIG. 6 is a graph showing a change in sheet temperature in the first embodiment.

FIG. 7 is a flowchart illustrating control processing of preliminary heating in the first embodiment.

FIG. 8 is a graph showing a change in sheet temperature in a modified example.

FIG. 9 is a view schematically illustrating the overall configuration of an image forming apparatus according to a second embodiment.

FIG. 10 is a graph showing a change in sheet temperature in the second embodiment.

FIG. 11 is a view schematically illustrating the overall configuration of an image forming apparatus according to a third embodiment.

FIG. 12 is a block diagram illustrating the configuration of a main part of the image forming apparatus according to the third embodiment.

FIG. 13 is a view schematically illustrating the overall configuration of an image forming apparatus according to a fourth embodiment.

FIG. 14 is a block diagram illustrating the configuration of a main part of the image forming apparatus according to the fourth embodiment.

### DETAILED DESCRIPTION

Hereinafter, one or more embodiments of the present invention will be described with reference to the drawings. However, the scope of the invention is not limited to the disclosed embodiments.

Embodiments for carrying out the present invention will be described in detail. Note that the embodiments described below are examples for realizing the present invention, and may be appropriately modified or changed depending on the configuration of an apparatus to which the present invention is applied and various conditions. The present invention is not limited to the following embodiments. Furthermore, in the drawings, the same components are denoted by the same reference signs, and description thereof is omitted as appropriate.

### First Embodiment

### [Configuration of the Image Forming Apparatus]

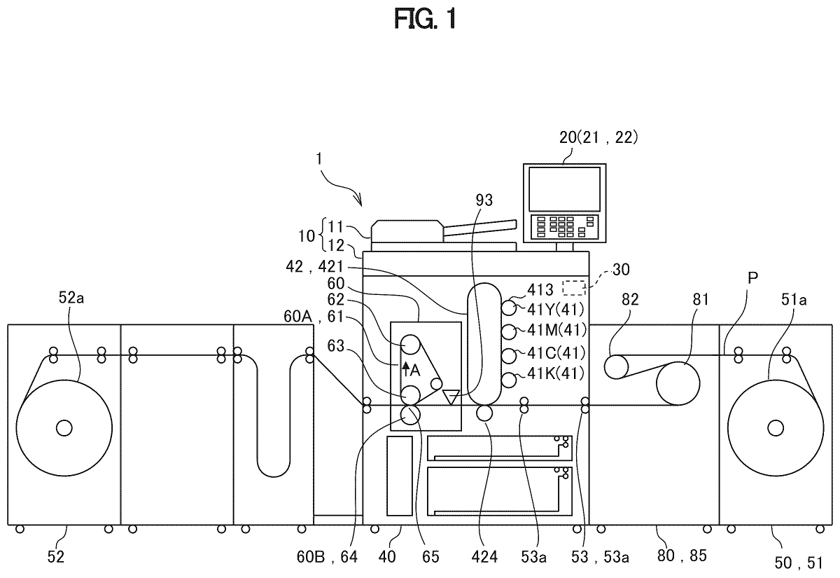

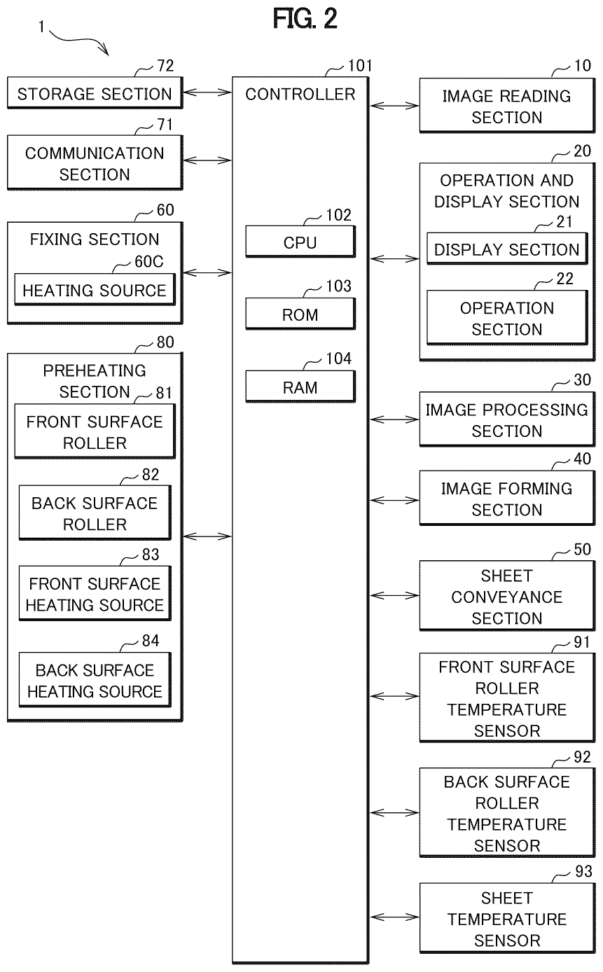

With reference to FIGS. 1 and 2, the configuration of an image forming apparatus 1 will be described below. FIG. 1 is a view schematically illustrating the overall configuration of an image forming apparatus 1 according to a first embodiment. FIG. 2 is a block diagram illustrating the configuration of a main part of the image forming apparatus 1 according to the first embodiment.

The image forming apparatus 1 is a color image forming apparatus employing an intermediate transfer system based on electrophotographic process technology. As illustrated in FIG. 1, the image forming apparatus 1 primary transfers toner images of respective colors of yellow (Y), magenta (M), cyan (C), and black (K) formed on the respective photosensitive drum 413 onto an intermediate transfer belt 421. The image forming apparatus 1 superimposes the toner images in four colors on the intermediate transfer belt 421 and then secondarily transfers the toner images onto a sheet P, to form a toner image.

For example, the image forming apparatus 1 adopts a tandem-system whereby photosensitive drums 413 corresponding to the four colors of Y, M, C, and K are arranged in series in a travel direction of the intermediate transfer belt 421, and the toner images of the respective colors are sequentially transferred onto the intermediate transfer belt 421 by a single sequence.

The sheet P is a target material (medium) to be printed. For example, the sheet P, which serves as a recording medium, may include various types of media such as printing sheet, thick paper, roll paper, and overhead projector (OHP) sheet.

As illustrated in FIG. 2, the image forming apparatus 1 includes an image reading section 10, an operation and display section 20, an image processing section 30, an image forming section 40, a sheet conveyance section 50, a fixing section 60, a communication section 71, a storage section 72, a preheating section 80, a front surface roller temperature sensor 91, a back surface roller temperature sensor 92, a sheet temperature sensor 93, and a controller 101.

The image reading section 10 includes an automatic document feeder 11 called ADF and a document image scanning device 12 which is a scanner. The image reading section 10 generates input image data based on a reading result of reading by the document image scanning device 12. The input image data undergoes predetermined image processing in the image processing section 30.

The automatic document feeder 11 conveys a document placed on a document tray by a conveyance mechanism and sends the document to the document image scanning device 12. The automatic document feeder 11 can continuously read images (including both sides) of a large number of documents placed on the document tray at once. Note that the automatic document feeder 11 may read not only single-sided images of a large number of documents placed on the document tray but also double-sided images of the documents continuously at once.

The document image scanning device 12 optically scans a document conveyed from the automatic document feeder 11 onto a contact glass or a document placed on the contact glass. The document image scanning device 12 reads a document image by forming an image of reflected light from the document on a light receiving surface of a charge coupled device (CCD) sensor.

The operation and display section 20 includes a liquid crystal display (LCD) with a touch screen, and functions as a display section 21 and an operation section 22. According to a display control signal input from the controller 101, the display section 21 displays various operation screens, states of images, individual function operating status, or the like. The operation section 22 includes various operation keys such as a numeric keypad, and a start key, receives various input operation from the user, and outputs an operation signal to the controller 101.

The image processing section 30 includes a circuit that applies digital image processing to input image data in accordance with initial settings or user settings. For example, the image processing section 30 performs gradation correction on the basis of gradation correction data under the control of the controller 101. Note that the gradation correction data is also referred to as a gradation correction table. The image processing section 30 also applies, to the input image data, not only the gradation correction but also various kinds of correction processing such as color correction and shading correction, compression processing, and the like. The image forming section 40 is controlled on the basis of the processed input image data.

The image forming section 40 includes an image forming unit 41 and an intermediate transfer section 42. The image forming unit 41 forms images with toner of a Y component, an M component, a C component, and a K component, on the basis of the input image data.

The image forming units 41Y, 41M, 41C, and 41K for the Y, M, C, and K components have a similar configuration. For convenience of illustration and description, common constituent elements are denoted by the same reference numerals, and Y, M, C, and K are added to the reference numerals when the constituent elements are distinguished from each other. In FIG. 1, only the constituent elements of the image forming unit 41Y for the Y-component are denoted by reference numerals, and the reference numerals of the constituent elements of the other image forming units 41M, 41C, and 41K are omitted.

The image forming unit 41 includes an exposure device (not illustrated), a developing device (not illustrated), the photosensitive drum 413, a charging device (not illustrated), and a drum cleaning device (not illustrated).

The photosensitive drum 413 is a negatively charged organic photoconductor formed, for example, with an undercoat layer, a charge generation layer, and a charge transport layer, sequentially laminated on a peripheral surface of an aluminum pipe which is an aluminum conductive cylindrical body. The charge generation layer is formed of an organic semiconductor in which a charge generating material is dispersed in a resin binder, and generates a pair of positive charge and negative charge upon exposure by the exposure device. For example, the charge generation material is phthalocyanine pigment, and the resin binder is polycarbonate. The charge transport layer is formed of a resin binder in which an electron-donating nitrogen-containing compound that is a hole transport material is dispersed, and transports the positive charges generated in the charge generation layer to the surface of the charge transport layer.

The charging device uniformly and negatively charges the surface of the photosensitive drum 413 having photoconductivity. The exposure device includes a semiconductor laser, for example, and emits laser beam corresponding to image of individual color components toward the photosensitive drum 413. A positive charge is generated in the charge generation layer of the photosensitive drum 413 and transported to the surface of the charge transport layer, whereby the surface charge of the photosensitive drum 413, which is a negative charge, is neutralized. On the surface of the photosensitive drum 413, an electrostatic latent image of each color component is formed due to a potential difference from the surroundings.

The developing device is a two-component type developing device, which visualizes an electrostatic latent image by causing toner of each of the color components to adhere to the surface of the photosensitive drum 413, thereby forming a toner image.

The drum cleaning device includes a drum cleaning blade that comes in sliding contact with the surface of the photosensitive drum 413, and removes transfer residual toner remaining on the surface of the photosensitive drum 413 after primary transfer.

The intermediate transfer section 42 includes an intermediate transfer belt 421, a primary transfer roller (not illustrated), a plurality of support rollers (not illustrated), a secondary transfer roller 424, and a belt cleaning device (not illustrated).

The intermediate transfer belt 421 is formed with an endless belt and stretched in a loop around the plurality of support rollers. At least one of the plurality of support rollers is constituted by a drive roller, and the others are constituted by driven rollers. For example, the drive roller is preferably a roller disposed downstream of the primary transfer roller for the K component in the belt traveling direction. This arrangement makes it possible to easily keep the running speed of the belt constant at a primary transfer section. The rotation of the drive roller causes the intermediate transfer belt 421 to run at a constant speed in the direction of arrow A.

The primary transfer roller is disposed on the inner peripheral surface of the intermediate transfer belt 421 so as to face the photosensitive drum 413 of each color component. The primary transfer roller is brought into pressure contact with the photosensitive drum 413 across the intermediate transfer belt 421. This forms a primary transfer nip for transferring a toner image from the photosensitive drum 413 to the intermediate transfer belt 421.

The secondary transfer roller 424 is disposed on the outer peripheral surface of the intermediate transfer belt 421 so as to face a backup roller that is disposed downstream of the drive roller in the belt traveling direction. The secondary transfer roller 424 is pressed against and brought into contact with the backup roller (not illustrated) across the intermediate transfer belt 421. This forms a secondary transfer nip for transferring a toner image from the intermediate transfer belt 421 onto the sheet P.

When the intermediate transfer belt 421 passes through each of the primary transfer nips, the toner image on each of the respective photosensitive drum 413 is sequentially superimposed and primarily transferred onto the intermediate transfer belt 421. Specifically, a primary transfer bias is applied to the primary transfer roller, and an electric charge having a polarity opposite to that of the toner is imparted to the back surface of the intermediate transfer belt 421, that is, the side in contact with the primary transfer roller, thereby electrostatically transferring the toner image onto the intermediate transfer belt 421.

Thereafter, when the sheet P passes through the secondary transfer nip, the toner image on the intermediate transfer belt 421 is secondarily transferred to the sheet P. Specifically, a secondary transfer bias is applied to the secondary transfer roller 424, and an electric charge having a polarity opposite to that of the toner is imparted to the back surface of the sheet P, that is, the side in contact with the secondary transfer roller 424, thereby electrostatically transferring the toner image to the sheet P. The sheet P on which the toner image has been transferred is conveyed toward the fixing section 60.

The belt cleaning device (not illustrated) includes a belt cleaning blade that comes into sliding contact with the surface of the intermediate transfer belt 421, and removes transfer residual toner remaining on the surface of the intermediate transfer belt 421 after the secondary transfer. Note that instead of the secondary transfer roller 424, a configuration in which a secondary transfer belt is stretched in a loop around a plurality of support rollers including a secondary transfer roller (i.e., a so-called belt-type secondary transfer unit) may be adopted.

The sheet conveyance section 50 includes a sheet feed section 51, a sheet ejection section 52, and a conveyance path section 53. The sheet feed section 51 includes a feed roller 51a that feeds a roll of sheet P downstream.

The sheet feed section 51 feeds the sheet P to the conveyance path section 53 on the downstream side via the preheating section 80. The conveyance path section 53 includes conveyance rollers 53a that hold and convey the sheet P, and conveys the sheet P to the image forming section 40. The conveyance path section 53 may include a sheet tension applying roller (not illustrated) that applies tension to the sheet P and a meandering adjustment roller (not illustrated) that adjusts meandering of the sheet P. In the image forming section 40, the toner image on the intermediate transfer belt 421 is secondarily transferred to one surface of the sheet P at a time, and a fixing process is performed in the fixing section 60. The sheet ejection section 52 includes a winding roller 52a that winds up the sheet P having the image formed thereon into a roll.

The fixing section 60 fixes the toner image onto the sheet P by heating and pressing the sheet P, onto which the toner image has been secondarily transferred and conveyed, at a fixing nip 65. The fixing section 60 is arranged as a unit within a fixing device, that is, within a housing.

The fixing section 60 includes an upper fixing section 60A, a lower fixing section 60B, and a heating source 60C. The upper fixing section 60A includes a fixing surface-side member disposed on the fixing surface side of the sheet P, that is, the front surface on which the toner image is formed. The lower fixing section 60B has a back surface-side support member disposed on the back surface of the sheet P, that is, the surface opposite to the fixing surface. The fixing nip 65 for holding and conveying the sheet P is formed by pressing the back surface-side support member against the fixing surface-side member.

The communication section 71 performs communication control for networks such as a local area network (LAN) or a wide area network (WAN).

The storage section 72 stores various types of data required for controlling the image forming apparatus 1. For example, the storage section 72 is configured by a nonvolatile memory such as a flash memory or a hard disk drive.

The preheating section 80 heats at least the front surface of the sheet P before the toner image is formed on the sheet P. The preheating section 80 may be either a contact type or a non-contact type. Note that details of the preheating section 80 will be described later.

The front surface roller temperature sensor 91, the back surface roller temperature sensor 92, and the sheet temperature sensor 93 are temperature sensors disposed at various positions in the image forming apparatus 1. For example, the front surface roller temperature sensor 91, the back surface roller temperature sensor 92, and the sheet temperature sensor 93 are general non-contact temperature sensors. The front surface roller temperature sensor 91, the back surface roller temperature sensor 92, and the sheet temperature sensor 93 will be described later in detail.

The controller 101 includes a CPU (Central Processing Unit) 102, a ROM (Read Only Memory) 103, and a RAM (Random Access Memory) 104. The CPU 102 reads a program corresponding to the processing content from the ROM 103, develops the program in the RAM 104, and centrally controls the operation of each block of the image forming apparatus 1 in cooperation with the developed program. At this time, various data stored in the storage section 72 are referenced.

The controller 101 transmits and receives various types of data to and from an external device (e.g., a personal computer) connected to communication networks such as a LAN or WAN via the communication section 71. For example, the controller 101 receives image data transmitted from the external device and controls the formation of a toner image on the sheet P based on the image data.

The controller 101 controls a drive current supplied to a drive motor (not illustrated) that rotates the photosensitive drum 413, thereby rotating the photosensitive drum 413 at a constant peripheral speed.

### [Configuration of the Fixing Section]

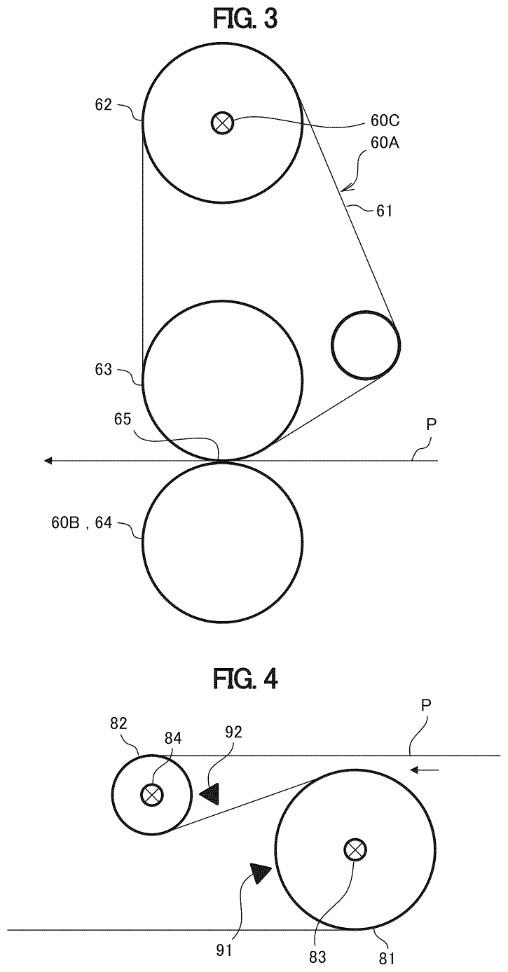

Referring to FIG. 3, the configuration of the fixing section 60 will be described. FIG. 3 is a view schematically illustrating the configuration of a fixing section in the first embodiment. Note that although the fixing method is described as a belt fixing method in this embodiment, the fixing method is not limited thereto.

As shown in FIG. 3, the upper fixing section 60A includes an endless fixing belt 61 as the fixing surface-side member, a heating roller 62, and an upper pressure roller 63. The fixing belt 61 is stretched between the heating roller 62 and the upper pressure roller 63 while maintaining a predetermined tension.

For example, the fixing belt 61 has an outer peripheral surface of a substrate made of polyimide (PI) covered with heat-resistant silicone rubber as an elastic layer, and its surface layer is covered or coated with a tube of perfluoroalkoxy (PFA) that is heat resistance resin.

The fixing belt 61 comes in contact with the sheet P on which the toner image is formed, and heats and fixes the toner image onto the sheet P within a predetermined temperature range.

The heating roller 62 heats the fixing belt 61. For example, the heating roller 62 has a built-in heating source 60C that is a halogen heater. The heating roller 62 has its outer peripheral surface of a cylindrical core made of aluminum covered with a resin layer coated with PTFE (polytetrafluoroethylene).

The temperature of the heating source 60C is controlled by the controller 101. When the heating source 60C heats the heating roller 62, the fixing belt 61 is also heated. Accordingly, the toner formed on the sheet P is heated. For example, the controller 101 controls the heating source 60C based on an on/off pattern of a half-wave unit of the duty ratio, thereby controlling the fixing temperature of the toner.

For example, the upper pressure roller 63 includes a solid core that is made of metal such as iron and is covered with an elastic layer. As an example of the material for the elastic layer, heat resistance silicon rubber can be used. The elastic layer may be a resin layer in which heat resistance silicon rubber is coated with PTFE.

The lower fixing section 60B includes a lower pressure roller 64 constituting the back surface-side support member. The lower pressure roller 64 has an outer periphery surface of a base material layer made of aluminum (Al) covered with an elastic layer. For example, the elastic layer may be made of heat resistance silicon rubber. The elastic layer may have a configuration in which heat resistance silicon rubber is covered with a resin layer of PFA tube serving as a surface release layer.

The lower pressure roller 64 may incorporate a heating source such as a halogen heater. As the heating source generates heat, the lower pressure roller 64 is heated. Accordingly, the toner formed on the sheet P is heated. For example, the controller 101 controls the heating source based on an on/off pattern of a half-wave unit of the duty ratio, thereby controlling the fixing temperature of the toner.

The lower pressure roller 64 is pressed against the upper pressure roller 63 with a predetermined fixing load through the fixing belt 61. In this manner, the fixing nip 65 for holding and conveying the sheet P is formed by the upper pressure roller 63, the fixing belt 61, and the lower pressure roller 64.

The lower pressure roller 64 is connected to a motor, a gear, or the like, and the driving force of the motor is transmitted to the lower pressure roller 64. The controller 101 outputs a drive signal to the motor that drives the lower pressure roller 64, and controls the peripheral speed of the lower pressure roller 64.

The upper fixing section 60A, the lower fixing section 60B, and the heating source 60C convey the sheet P while heating and pressurizing the sheet P at the fixing nip 65, thereby fixing the unfixed toner image onto the sheet P.

### [Configuration of the Preheating Section]

Hereinafter, the configuration of the preheating section 80 will be described.

The preheating section 80 prevents fixing under-offset, image unevenness, and image formation failure. As illustrated in FIG. 1, the preheating section 80 is disposed upstream of the intermediate transfer section 42 in the sheet conveyance direction (hereinafter, “upstream”) and downstream of the sheet feed section 51 in the sheet conveyance direction (hereinafter, “downstream”).

The preheating section 80 includes a housing 85 separate from the main body of the image forming apparatus 1. In other words, the preheating section 80 is stored in a housing different from the image forming section 40 and the fixing section 60 which are the main body of the image forming apparatus 1. For example, the housing 85 is a box-shaped housing formed of the same material as the main body of the image forming apparatus 1. Accordingly, the image forming apparatus 1 can suppress the temperature rise of the main body due to the preheating and reduce the toner fixation. Furthermore, the image forming apparatus 1 can suppress heat dissipation in the preheating section 80. Note that the preheating section 80 may not have the housing 85 and may be stored in the same housing as the main body of the image forming apparatus 1.

FIG. 4 is a view schematically illustrating a first exemplary configuration of the preheating section in the first embodiment. As illustrated in FIG. 4, the preheating section 80 includes a front surface roller 81 and a back surface roller 82. In the preheating section 80, the front surface roller 81 is located downstream of the back surface roller 82.

The front surface roller 81 is disposed in contact with the front surface of the sheet P, and heats the front surface of the sheet P. The front surface roller 81 incorporates a front surface heating source 83 for heating the front surface side of the sheet P. For example, the front surface heating source 83 is a halogen heater. The diameter of the front surface roller 81 is larger than the diameter of the back surface roller 82. A front surface roller temperature sensor 91 that detects the temperature of the front surface roller 81 is arranged in the vicinity of the front surface roller 81.

The back surface roller 82 is disposed in contact with the back surface of the sheet P at a position not facing the front surface roller 81, and heats the back surface of the sheet P. The back surface roller 82 incorporates a back surface heating source 84 for heating the back surface side of the sheet P. For example, the back surface heating source 84 is a halogen heater. The back surface roller 82i disposed at a position not facing the front surface roller 81 with the sheet P interposed therebetween. A back surface roller temperature sensor 92 for detecting the temperature of the back surface roller 82 is disposed in the vicinity of the back surface roller 82. This can increase the contact area with the sheet P, thereby improving heating efficiency. Furthermore, because the behavior of the sheet P is stabilized and the sheet wrinkles are reduced, a sheet temperature can be controlled with high accuracy. For example, when the sheet P is a multilayer medium, the preheating section 80 may be configured as illustrated in FIG. 4. Note that the sheet temperature corresponds to the “temperature of a recording medium” as defined in the claims.

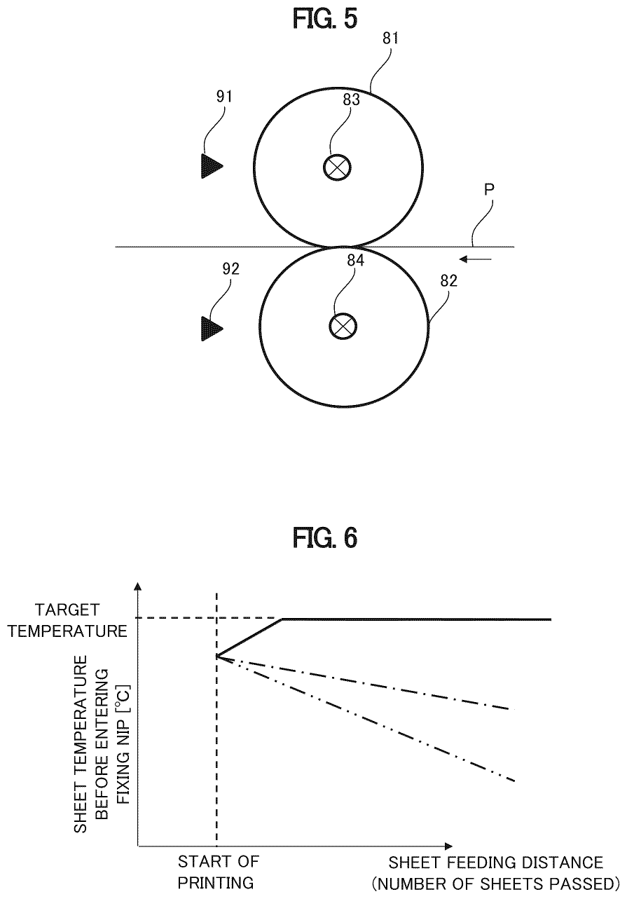

FIG. 5 is a view schematically illustrating a second exemplary configuration of the preheating section in the first embodiment. As illustrated in FIG. 5, the back surface roller 82 may be disposed in such a manner as to contact the back surface of the sheet P at a position facing the front surface roller 81, to heat the back surface of the sheet P. In other words, the front surface roller 81 and the back surface roller 82 are arranged at positions opposite to each other with the sheet P interposed therebetween. The diameter of the front surface roller 81 is equal to the diameter of the back surface roller 82. This can stabilize the behavior of the sheet P and reduce paper wrinkles, so that the sheet temperature can be controlled with high accuracy. For example, when the sheet P is a flat cut sheet, the preheating section 80 may be configured as illustrated in FIG. 5.

Note that although the preheating section 80 is described as heating the front surface and the back surface of the sheet P, the preheating section 80 may heat only the front surface of the sheet P. In this case, the preheating section 80 may not include the back surface roller 82.

### <Control of Preheating>

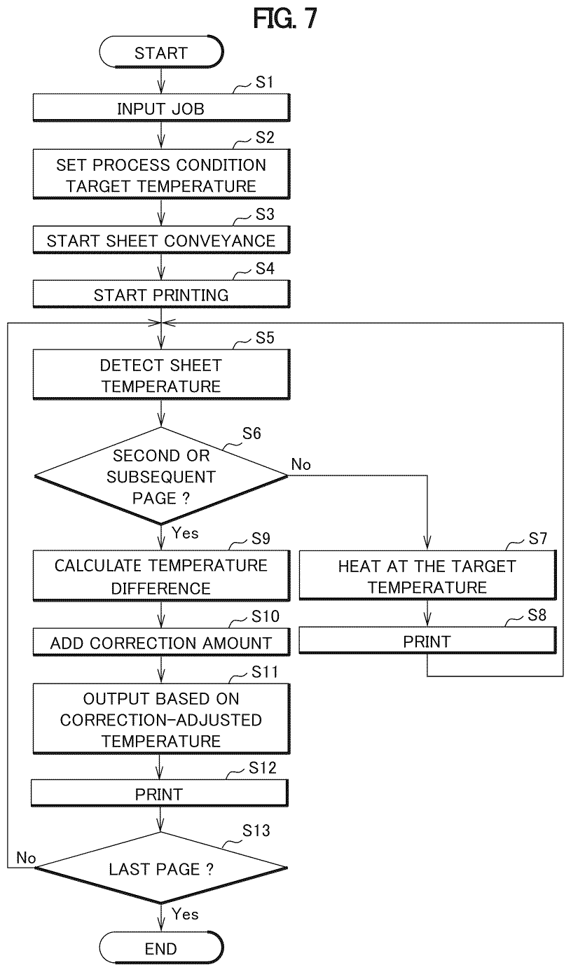

The control of the preheating will be described with reference to FIG. 6 and FIG. 7. For example, when printing on the sheet P that has been placed in a low-temperature environment, the sheet temperature may change (decrease) during printing. This makes it difficult to stabilize the temperature of the sheet P before it enters the fixing nip 65. Further, when handling thick paper or multilayer media, heating only from the back surface may be insufficient, and the sheet temperature may become unstable. As a result, fixing under-offset may occur. For this reason, the image forming apparatus 1 is configured to detect the temperature of the sheet P before it enters the fixing nip 65, regardless of whether it is before or during printing, and to control the preheating accordingly.

The sheet temperature sensor 93 is a temperature detection section that detects the sheet temperature before the toner image is fixed to the sheet P. For example, the sheet temperature sensor 93 is disposed on the upper side of the entrance of the fixing section 60 and detects the temperature of the front surface of the sheet P immediately before the sheet P enters the fixing nip 65. The sheet temperature sensor 93 outputs the detected sheet temperature to the controller 101.

The controller 101 controls heating by the preheating section 80 during printing, based on the sheet temperature detected by the sheet temperature sensor 93. For example, the controller 101 controls the front surface heating source 83 and the back surface heating source 84 so that the sheet temperature input from the sheet temperature sensor 93 is maintained at a target temperature set in advance. At this time, the controller 101 can use general feedback control such as PID control. The target temperature can be arbitrarily set by the user using the operation and display section 20.

FIG. 6 is a graph showing a change in sheet temperature in the first embodiment. In FIG. 6, the vertical axis represents the sheet temperature before entering the fixing nip 65, and the horizontal axis represents the sheet feeding distance. Further, in FIG. 6, the solid line represents the case where preheating is controlled by the image forming apparatus 1, the one-dot chain line represents the case where preheating is controlled by the method described in JP 2023-046717 A, and the two-dot chain line represents the case where no preheating is performed.

As illustrated by the two-dot chain line in FIG. 6, in the case where no preheating is performed, the sheet temperature greatly decreases after the start of printing. As indicated by the one-dot chain line, in the case where the preheating is controlled by the method described in JP 2023-046717 A, the sheet temperature gently decreases after the start of printing. In contrast, as indicated by the solid line, in the case where the preheating is controlled by the image forming apparatus 1, the sheet temperature rises to the target temperature after the start of printing, and the sheet temperature is maintained at the target temperature.

FIG. 7 is a flowchart illustrating control processing of preliminary heating in the first embodiment. As shown in FIG. 7, in step S1, the user inputs a job such as printing to the image forming apparatus 1. That is, the user sets a job in the controller 101 using the operation and display section 20.

In step S2, the user sets process condition in the controller 101 by using the operation and display section 20. For example, the process condition includes a target temperature and characteristic information of the sheet P described below.

In step S3, the controller 101 instructs the sheet conveyance section 50 to convey sheet P. In response to the instruction, the sheet conveyance section 50 starts conveyance of the sheet P.

In step S4, the controller 101 starts printing. That is, the controller 101 centrally controls the operation of each block of the image forming apparatus 1 in order to start the printing job set in step S1.

In step S5, the sheet temperature sensor 93 detects the temperature of the sheet before the sheet enters the fixing nip 65.

In step S6, the controller 101 determines whether or not the sheet P to be printed is the second or subsequent page. If the sheet P to be printed is not the second or subsequent page (No in step S6), the controller 101 proceeds to the process of step S7. If the sheet P to be printed is the second or subsequent page (YES in step S6), the controller 101 proceeds to processing in step S9.

In step S7 (detection step), the controller 101 controls the heating by the preheating section 80 so that the sheet temperature detected by the sheet temperature sensor 93 keeps the target temperature.

In step S8, the controller 101 performs printing on the sheet P. That is, the controller 101 centrally controls the operation of each block of the image forming apparatus 1 so as to print the first page.

In step S9 (calculation step), the controller 101 calculates a temperature difference between the target temperature and the sheet temperature.

In step S10, the controller 101 adds the temperature difference calculated in step S9 to the target temperature as a correction amount. The target temperature to which the correction amount is added may be referred to as a correction-adjusted temperature.

In step S11 (heating step), the controller 101 controls heating by the preheating section 80 so that the sheet temperature detected by the sheet temperature sensor 93 is maintained at the correction-adjusted temperature. Then, the preheating section 80 heats at least the front surface of the sheet P at a temperature based on the correction amount and the target temperature.

In step S12 (printing step), the controller 101 performs printing on the sheet P. That is, the controller 101 centrally controls the operation of each block of the image forming apparatus 1 so as to print the second and subsequent pages.

In step S13, the controller 101 determines whether or not the printed sheet P is the last page. If the printed sheet P is not the last page (No in step S13), the controller 101 returns to the process of step S5. If the printed sheet P is the last page (Yes in step S13), the controller 101 ends the printing.

As described above, the image forming apparatus 1 according to the first embodiment detects the temperature of the sheet P before the sheet P enters the fixing nip 65, regardless of whether it is before or during printing, and controls preheating so that the sheet temperature remains constant. As a result, the image forming apparatus 1 can stabilize the sheet temperature even during printing. Furthermore, since the image forming apparatus 1 heats at least the front surface of the sheet P, the sheet temperature can be stabilized even when handling thick paper or multilayer media.

Furthermore, since the image forming apparatus 1 detects the sheet temperature immediately before the fixing nip 65 and feeds it back to the controller 101, sufficient responsiveness can be achieved. In contrast, according to the invention described in JP 2017-116753 A, the sheet temperature must be detected and fed back over a short distance—just before toner image fixing and on the preheating—making it difficult to achieve sufficient responsiveness. As a result, in the invention described in JP 2017-116753 A, if the sheet temperature fluctuates before preheating, it becomes difficult to stabilize the sheet temperature.

### (Modified Example: Control of Preheating)

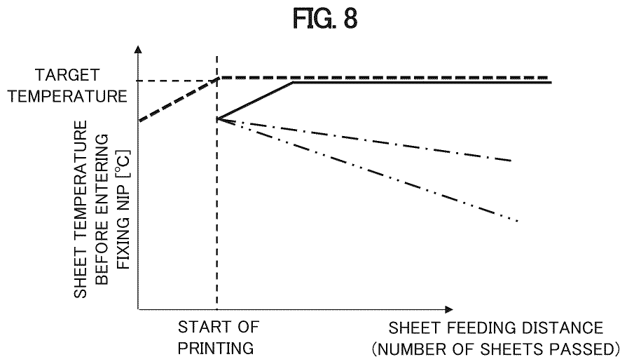

Referring to FIG. 8, a modified example of the control of preheating will be described.

The sheet temperature sensor 93 detects the temperature of the sheet P as it is passed through and enters the fixing nip 65 before printing. The controller 101 may start printing when the sheet temperature detected by the sheet temperature sensor 93 is equal to or higher than the target temperature set in advance.

FIG. 8 is a graph showing a change in sheet temperature in the modified example. In FIG. 8, the broken line represents the case where preheating is controlled by the method of this modified example. Other aspects are the same as those shown in FIG. 6. As shown by the broken line in FIG. 8, when preheating is controlled by the method of this modified example, since printing starts after the sheet temperature reaches the target temperature, the sheet temperature is maintained at the target temperature throughout the printing process.

### Second Embodiment

### [Configuration of the Image Forming Apparatus]

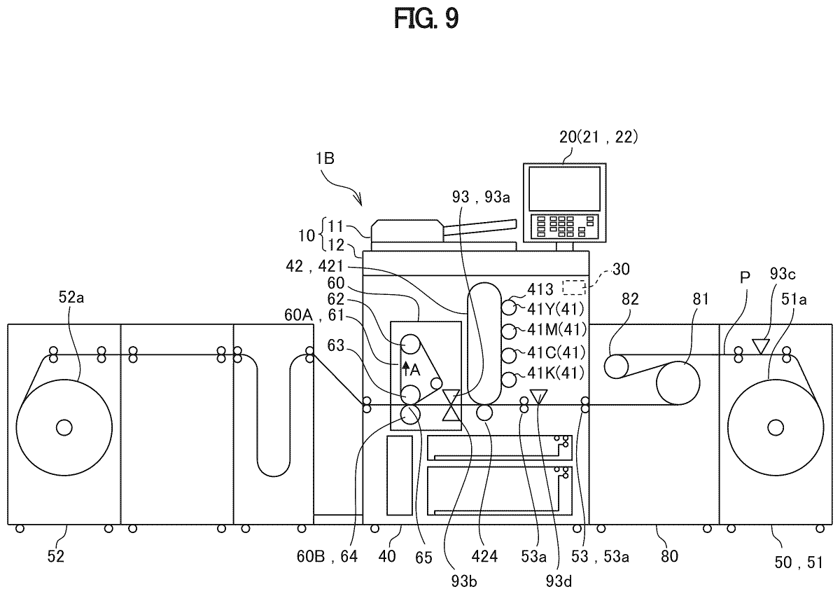

With reference to FIG. 9, the configuration of the image forming apparatus 1B according to the second embodiment will be described focusing on differences from the first embodiment. FIG. 9 is a view schematically illustrating the overall configuration of the image forming apparatus 1B according to the second embodiment.

The sheet temperature sensors 93a to 93d detect the sheet temperatures at a plurality of positions. The controller 101 controls heating by the preheating section based on the sheet temperatures detected at the plurality of positions by the sheet temperature sensors 93a to 93d.

The sheet temperature sensor 93a is the same as the sheet temperature sensor 93 shown in FIG. 1. The sheet temperature sensor 93b is disposed on the lower side of the entrance of the fixing section 60, and detects the temperature of the back surface of the sheet P immediately before the sheet P enters the fixing nip 65. For example, the sheet temperature sensor 93b is disposed to face the sheet temperature sensor 93a with the sheet P interposed therebetween. In this case, the controller 101 controls heating by the preheating section 80 for each of the front surface and the back surface of the sheet P. That is, the controller 101 controls the front surface heating source 83 based on the sheet temperature of the front surface detected by the sheet temperature sensor 93a, and controls the back surface heating source 84 based on the sheet temperature of the back surface detected by the sheet temperature sensor 93b. In this way, the image forming apparatus 1B can detect the temperatures of both sides of the sheet P, and can appropriately control preheating even if the front and back sides of the sheet P are made of different materials.

The sheet temperature sensor 93c detects the sheet temperature in the sheet feed section 51 that feeds the sheet P. For example, the sheet temperature sensor 93c is disposed in the sheet feed section 51 and detects the temperature of the front surface of the sheet P conveyed to the image forming section 40. This allows the image forming apparatus 1B to perform detection of the sheet temperature at an early stage before preheating and to feed it back to the controller 101, so that the temperature can reach the target temperature more quickly.

The sheet temperature sensor 93d detects the temperature in the image forming section 40 that forms a toner image on the sheet P. For example, the sheet temperature sensor 93d is disposed in front of the image forming unit 41 and detects the temperature of the front surface of the sheet P. This allows the image forming apparatus 1B to detect the sheet temperature and feed it back to the controller 101 even before the toner image is transferred, so that toner melting due to overheating of the sheet P can be prevented.

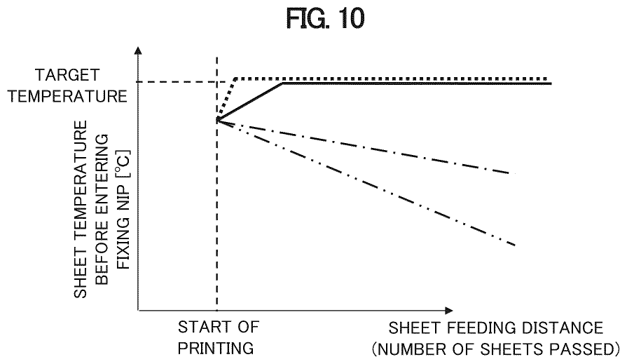

FIG. 10 is a graph showing a change in sheet temperature in the second embodiment. In FIG. 10, the dotted line represents the case where preheating is controlled in the image forming apparatus 1B. Other aspects are the same as those shown in FIG. 6. As shown in FIG. 10, if the sheet temperature sensor 93c is provided, the sheet temperature can be detected at an early stage, so that the sheet temperature cab be kept constant shortly after printing begins.

As described above, the image forming apparatus 1B according to the second embodiment can detect the sheet temperature at a plurality of positions and feed the information back to the controller 101, thereby enabling more precise control of preheating.

### Third Embodiment

### [Configuration of the Image Forming Apparatus]

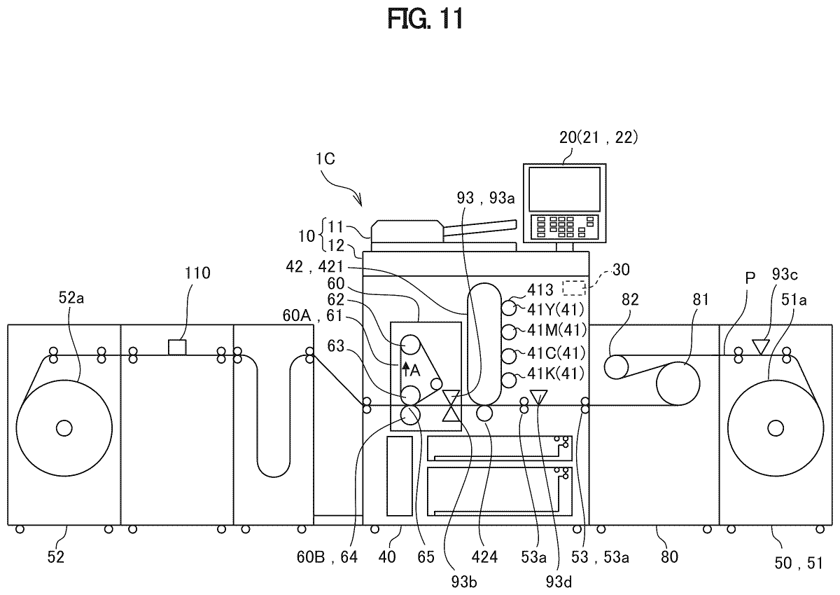

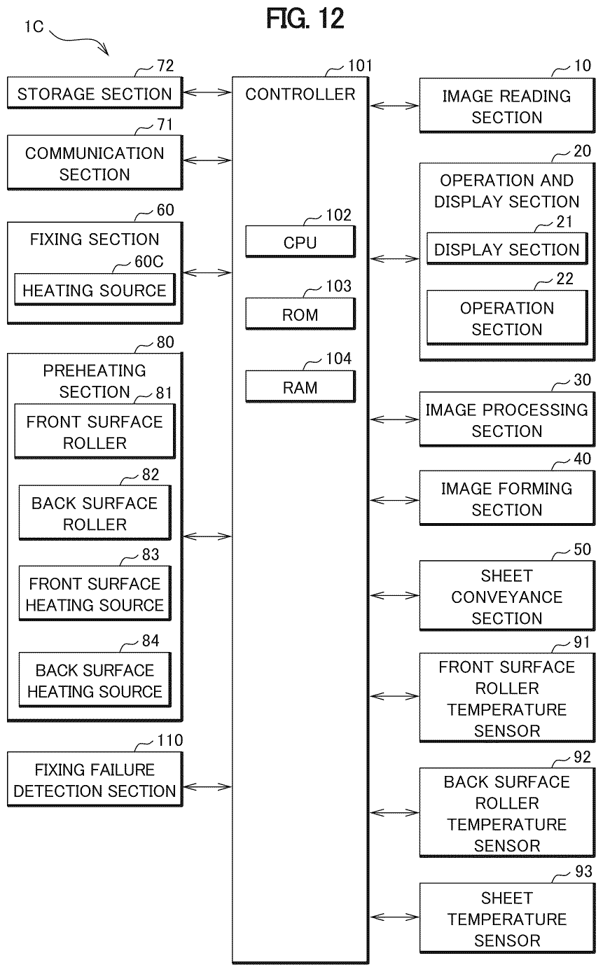

With reference to FIG. 11 and FIG. 12, the configuration of the image forming apparatus 1C according to the third embodiment will be described focusing on differences from the second embodiment. FIG. 11 is a view schematically illustrating the overall configuration of the image forming apparatus 1C according to the third embodiment. FIG. 12 is a block diagram illustrating the configuration of a main part of the image forming apparatus 1C according to the third embodiment.

The controller 101 receives the determination result of fixing failure, and controls heating by the preheating section 80, based not only on the sheet temperature but also on the determination result of fixing failure. The determination result of the fixing failure is information indicating whether or not fixing failure such as fixing under-offset and gloss variation occurs. The gloss variation indicates that the gloss is too strong or too weak. For example, the user visually determines the fixing failure and inputs the determination result to the controller 101. Further, the image forming apparatus 1C may include a fixing failure detection section 110 that determines a fixing failure.

For example, when an offset occurs, the controller 101 increases the target temperature by a preset value. Similarly, if the gloss is too strong, the controller 101 also raises the target temperature by a preset value. Conversely, if the gloss is too weak, the controller 101 lowers the target temperature by a preset value.

The fixing failure detection section 110 determines fixing failure based on the image formed on the sheet P after toner image fixation, and outputs a detection result of fixing failure to the controller 101. The fixing failure detection section 110 is disposed upstream of the sheet ejection section 52 and includes a scanner that reads an image on the sheet P conveyed from the fixing section 60. Based on the reading result of the sheet P, the fixing failure detection section 110 generates read image data. The fixing failure detection section 110 compares the read image data with the input image data of the image forming section 40 to determine whether a fixing failure has occurred. At this time, general image processing techniques, such as deep learning, may be used by the fixing failure detection section 110.

As described above, the image forming apparatus 1C according to the third embodiment takes into account the fixing failure determination result in the control of preheating, thereby further stabilizing the sheet temperature.

### Fourth Embodiment

### [Configuration of the Image Forming Apparatus]

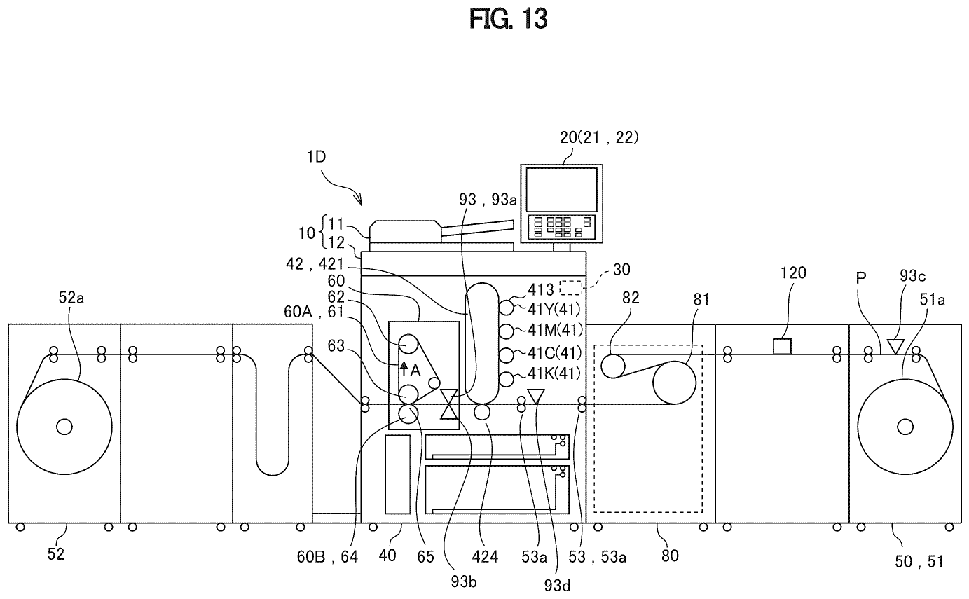

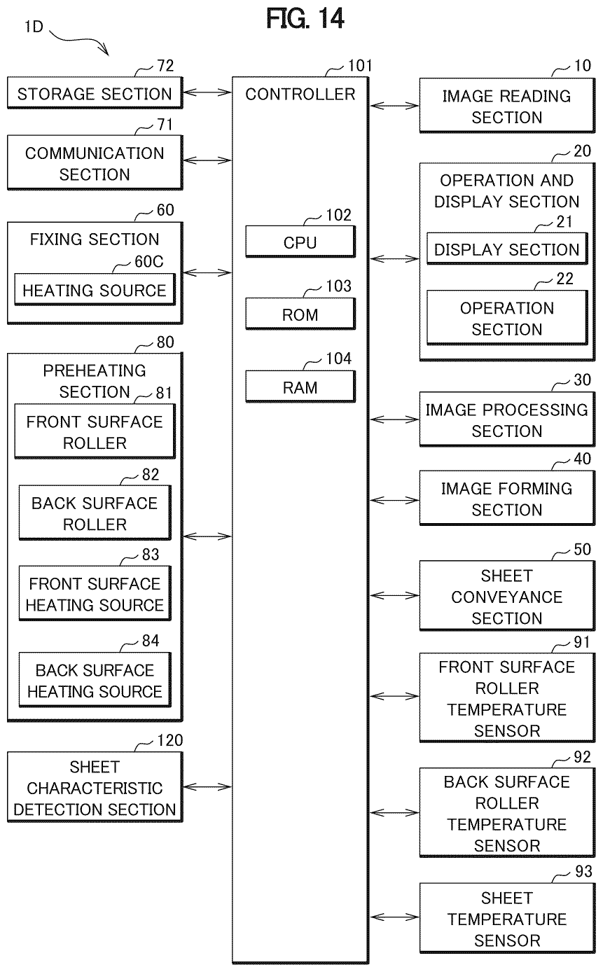

With reference to FIG. 13 and FIG. 14, the configuration of the image forming apparatus 1D according to the fourth embodiment will be described focusing on differences from the second embodiment. FIG. 13 is a view schematically illustrating the overall configuration of the image forming apparatus 1D according to the fourth embodiment. FIG. 14 is a block diagram illustrating the configuration of a main part of the image forming apparatus 1D according to the fourth embodiment.

Characteristic information of the sheet is input to the controller 101, and the controller 101 controls heating by the preheating section 80 based not only on the sheet temperature but also on the characteristic information of the sheet P. The characteristic information of the sheet P is information indicating the characteristics and properties of the sheet P, and includes at least one of the sheet type and the basis weight of the sheet P. For example, the user may input the characteristic information of the sheet P into the controller 101. Alternatively, the image forming apparatus 1C may include a sheet characteristic detection section 120 that detects the characteristics of the sheet P.

Here, the type or basis weight of the sheet P indicates how easily heat is transferred through the sheet. Accordingly, the controller 101 changes the target temperature based on the type or basis weight of the sheet P. When the basis weight of the sheet P exceeds a predetermined threshold value, the controller 101 increases the target temperature by a preset value. On the other hand, when the basis weight of the sheet P is less than the predetermined threshold value, the controller 101 decreases the target temperature by a preset value.

The sheet characteristic detection section 120 detects characteristic information of the sheet P, and outputs the characteristic information to the controller 101. The sheet characteristic detection section 120 is disposed between the sheet feed section 51 and the preheating section 80, and detects characteristic information of the sheet P conveyed from the sheet feed section 51. For example, the sheet characteristic detection section 120 includes a sensor for measuring the type and basis weight of the sheet P.

As described above, the image forming apparatus 1D according to the fourth embodiment takes into account the characteristic information of the sheet P in the control of preheating, thereby further stabilizing the sheet temperature.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a temperature detection section configured to detect a temperature of a recording medium before a toner image is fixed to the recording medium;
a preheating section configured to heat at least a front surface of the recording medium before the toner image is formed on the recording medium; and
a controller configured to control heating by the preheating section during printing based on the temperature of the recording medium detected by the temperature detection section.

2. The image forming apparatus according to claim 1, wherein
the preheating section heats a front surface and a back surface of the recording medium, and
the controller controls heating by the preheating section for each of a front surface and a back surface of the recording medium.

3. The image forming apparatus according to claim 1, wherein
the temperature detection section detects the temperature of the recording medium at a plurality of positions, and
the controller controls heating by the preheating section based on the temperature of the recording medium detected at the plurality of positions by the temperature detection section.

4. The image forming apparatus according to claim 3, wherein
the temperature detection section detects the temperature of the recording medium at an image forming section that forms the toner image on the recording medium and at a sheet feed section that feeds the recording medium.

5. The image forming apparatus according to claim 3, wherein
the temperature detection section detects the temperature of the recording medium at a front surface and a back surface of the recording medium.

6. The image forming apparatus according to claim 1, wherein
the temperature detection section detects a temperature of a recording medium as it is passed through and enters a fixing nip before printing, and
the controller starts printing when the temperature of the recording medium detected by the temperature detection section is equal to or higher than a target temperature set in advance.

7. The image forming apparatus according to claim 1, wherein the preheating section has a housing different from a main body of the image forming apparatus.

8. The image forming apparatus according to claim 1, wherein the preheating section includes:
a front surface-side roller that is disposed in contact with the front surface of the recording medium and that heats the front surface of the recording medium; and
a back surface-side roller that is disposed at a position not facing the front surface-side roller, in contact with the back surface of the recording medium, and that heats the back surface of the recording medium.

9. The image forming apparatus according to claim 1, wherein the preheating section includes:
a front surface-side roller that is disposed in contact with the front surface of the recording medium and that heats the front surface of the recording medium; and
a back surface-side roller that is disposed at a position facing the front surface-side roller, in contact with the back surface of the recording medium, and that heats the back surface of the recording medium.

10. The image forming apparatus according to claim 1, wherein the controller receives an input of a determination result of fixing failure, and controls heating by the preheating section based on the determination result of the fixing failure in addition to the temperature of the recording medium.

11. The image forming apparatus according to claim 10, further comprising a fixing failure detection section that determines fixing failure from an image after a toner image is fixed to the recording medium, and outputs a determination result of the fixing failure to the controller.

12. The image forming apparatus according to claim 1, wherein the controller receives an input of a characteristic information of the recording medium, and controls heating by the preheating section based on the characteristic information of the recording medium in addition to the temperature of the recording medium.

13. The image forming apparatus according to claim 12, wherein the characteristic information of the recording medium includes at least one of a type and a basis weight of the recording medium.

14. The image forming apparatus according to claim 12, further comprising a recording medium characteristic detection unit configured to detect characteristic information of the recording medium and output the characteristic information to the controller.

15. An image forming method comprising the steps of:
a detection step of detecting a temperature of a recording medium before a toner image is fixed to the recording medium;
a calculation step of calculating a temperature difference between the temperature of the recording medium and a preset target temperature as a correction amount;
a heating step of heating at least a front surface of the recording medium at a temperature based on the correction amount and the target temperature; and
a printing step of printing on the recording medium in which at least the front surface has been heated.
